(19) United States
(12) Patent Application Publication
(10) Pub. No.: US 2012/0239526 A1
(43) Pub. Date: Sep. 20, 2012

(54) INTERACTIVE MUSIC CONCERT METHOD AND APPARATUS

(76) Inventor: Steven L. Revare, Prairie Village, KS (US)

(21) Appl. No.: 13/424,211

(22) Filed: Mar. 19, 2012

Related U.S. Application Data
(60) Provisional application No. 61/454,321, filed on Mar. 18, 2011.

(51) Int. Cl. G06Q 30/06; G06F 3/16

(52) U.S. Cl. 705/26.8; 715/727

(57) ABSTRACT

An interactive music concert method and apparatus provides interaction between a performer and concert attendees to communicate and actively participate in a concert. The performer enters concert information into a server by application, which is then accessed wirelessly by a concert attendee with an electronic device running interactive software. Animations from the server are dynamically displayed on the electronic device.

### CROSS REFERENCE TO RELATED APPLICATION

This application claims the benefit of co-pending application Ser. No. 61/454,321, filed Mar. 18, 2011, entitled INTERACTIVE MUSIC CONCERT METHOD AND APPARATUS.

### FIELD

The present invention relates to a method and apparatus for interacting with a music concert and, more particularly, to a method and apparatus to manage the presentation of a music concert and receive input from and interact with concert attendees.

### BACKGROUND

In the past, individuals have attended music concerts to hear and see a musician or band perform live. The performer typically has a predetermined script of songs to play or sing within the time allotted for the concert. There may be little or no substantive interaction between the performer and the crowd. At the end of the performance, the performer may be encouraged to play an encore of one or more additional songs. These additional songs are typically preselected by the performer. At the end of the performance, the attendees may be left with a feeling of having been entertained but without a real connection with the performer.

### SUMMARY

The present invention provides a method and apparatus for a performer to interact and communicate with concert attendees and for the attendees to interact and communicate with the performer, each other, and/or one or more third parties. The performance is initially set up on a central server where a schedule is input and stored. The schedule may include the date, time and location of the next concert as well as future concerts. Additionally, an ordered list of songs to perform may also be entered and stored for a particular concert. A list of encore songs may be entered and stored for later selection by the concert attendees. Each selected song may have a multimedia file and/or a link to purchase the song associated with it.

At the concert, the performer initializes the server application to begin the performance. Attendees may link to the server wirelessly through a land area network, Wifi network, or cellular network, for example, using a portable electronic device with networking capability such as an mp3 player, iPod, Smartphone or iPhone, for example. As each song is performed, the multimedia file associated with the song may be broadcast to the portable electronic devices or activated if it was preinstalled. Graphics or animations associated with the music may be varied interactively by the user by moving the electronic device. The user may select to download the song or view the lyrics, for example. The user may select an encore screen to vote on the song to be played during an encore performance.

### DESCRIPTION OF THE DRAWINGS

FIG. 1 is a functional block diagram of the major components of the present invention.

FIGS. 2-9 are flow charts illustrating the functions of the server application software.

FIGS. 10-20 are flow charts illustrating the functions of the user application software.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable or preferred for a given purpose in connection with the invention implies that mixtures or combinations of any two or more members of the group or class may be equally suitable or preferred.

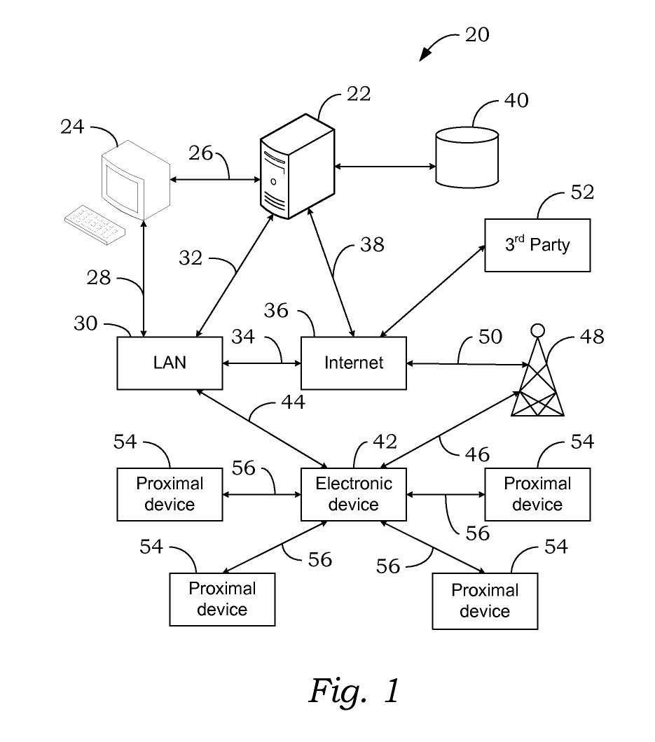

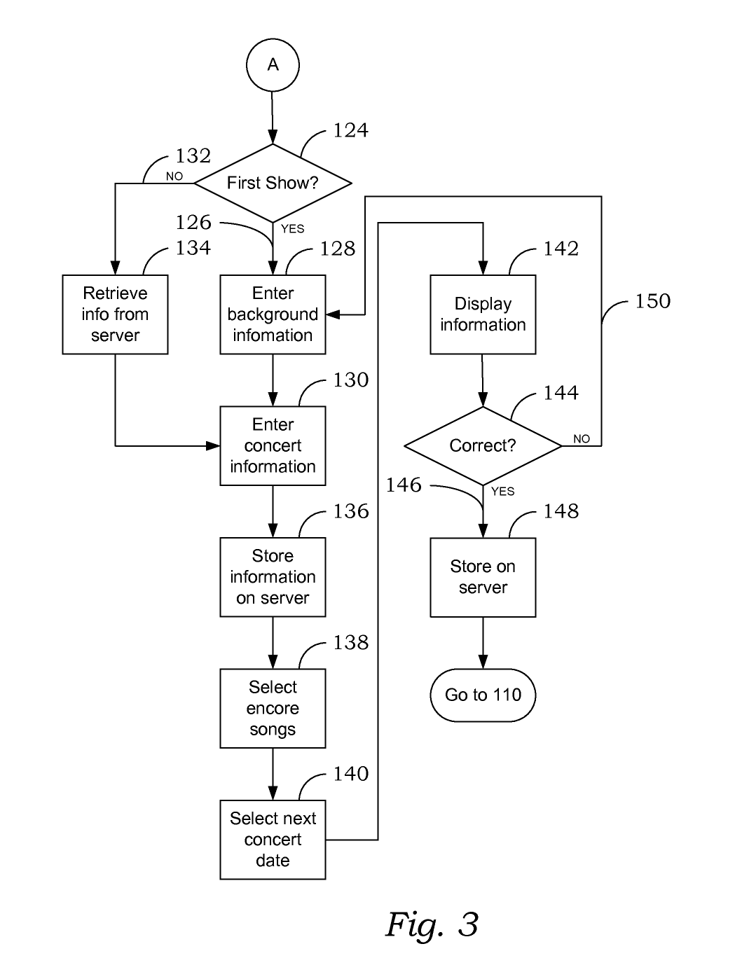

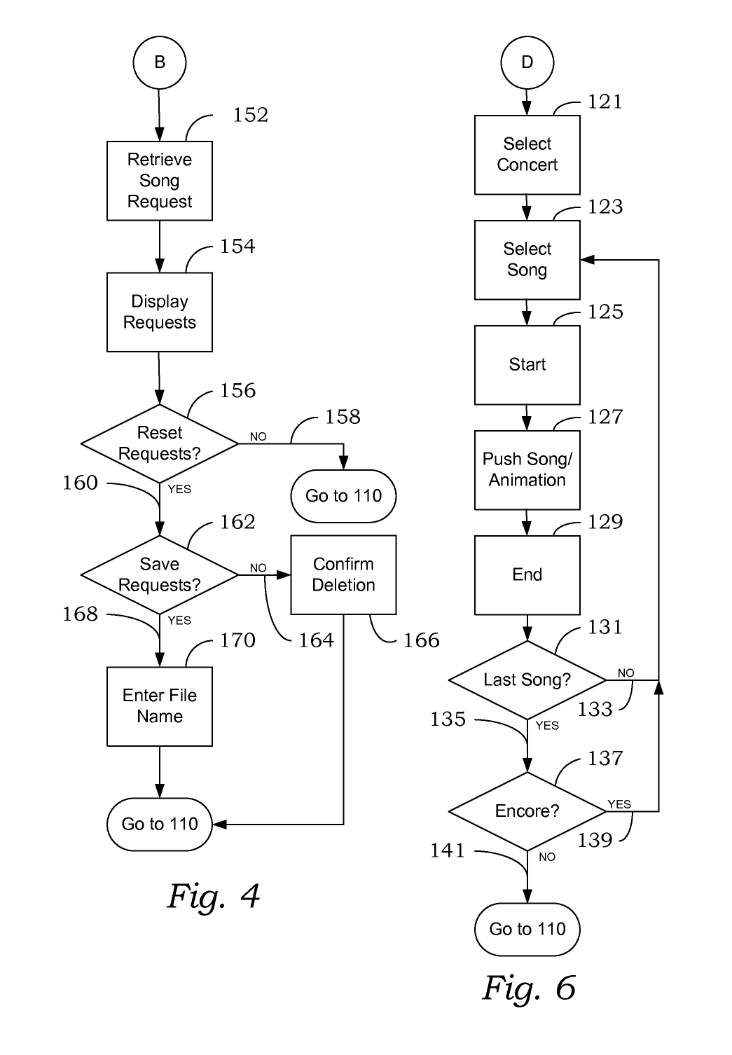

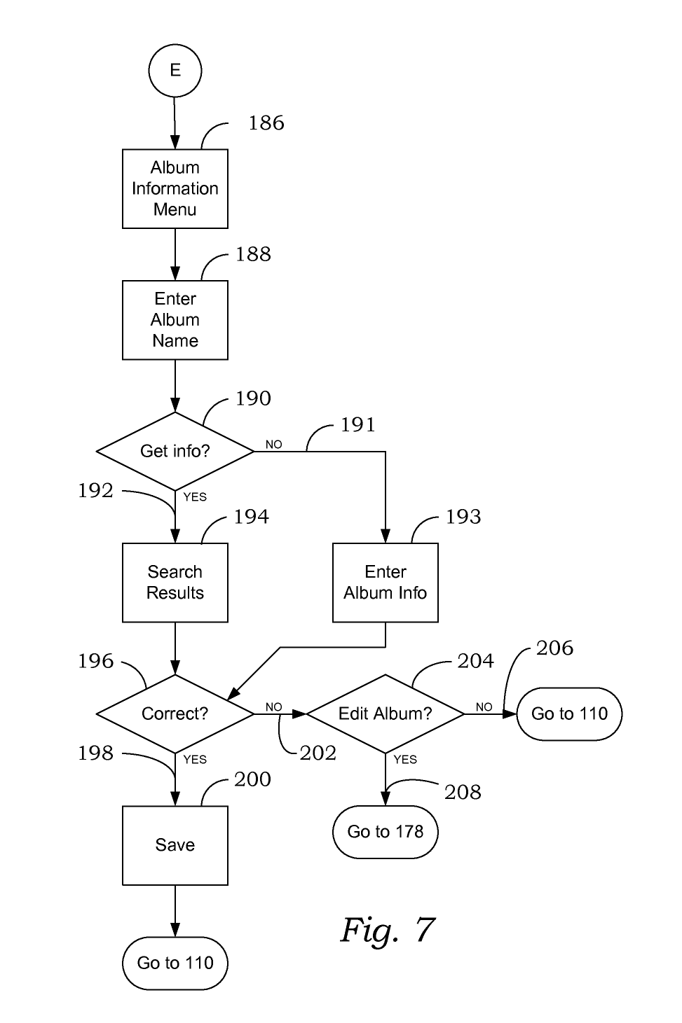

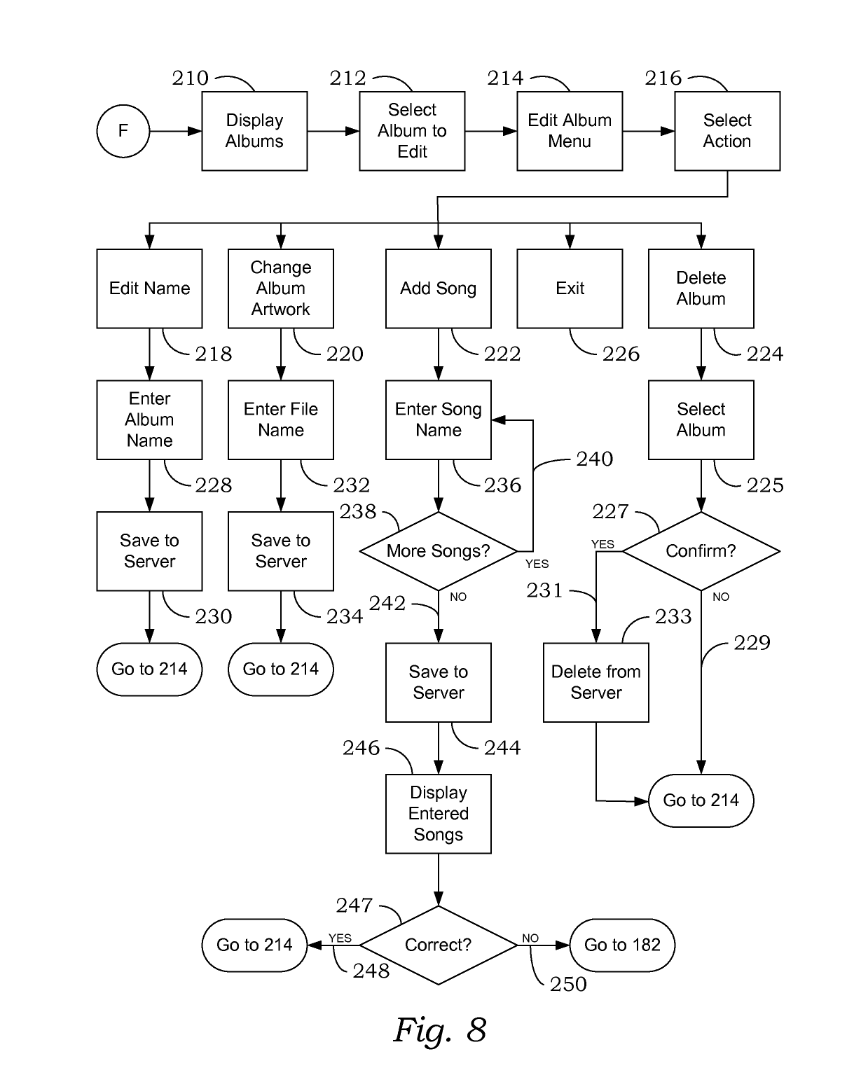

Referring initially to FIGS. 1-9, a system for providing an interactive interface between a performer and a concert attendee is generally indicated by reference numeral 20. The interactive interface includes a server or central computer 22 and a local computer 24 connected to the server 22 directly 26, wirelessly or wired 28 through a router or switch 30 which is connected directly or wirelessly 32 to the server 22. Alternatively, the router 30 may be connected 34 to the internet 36 through an internet service provider and then connected 38 to the server 22. The local computer 24 may be used by a performer (or someone associated with the performer) to access the server 22 or the server 22 may be accessed by the performer directly. As used herein, performer may include the performer him/herself or anyone associated with or authorized by the performer to access the server 22. The local computer 24 may be a mobile device such as a smartphone, iPad, iPod, iPhone or other portable device used to access the server 22, for example.

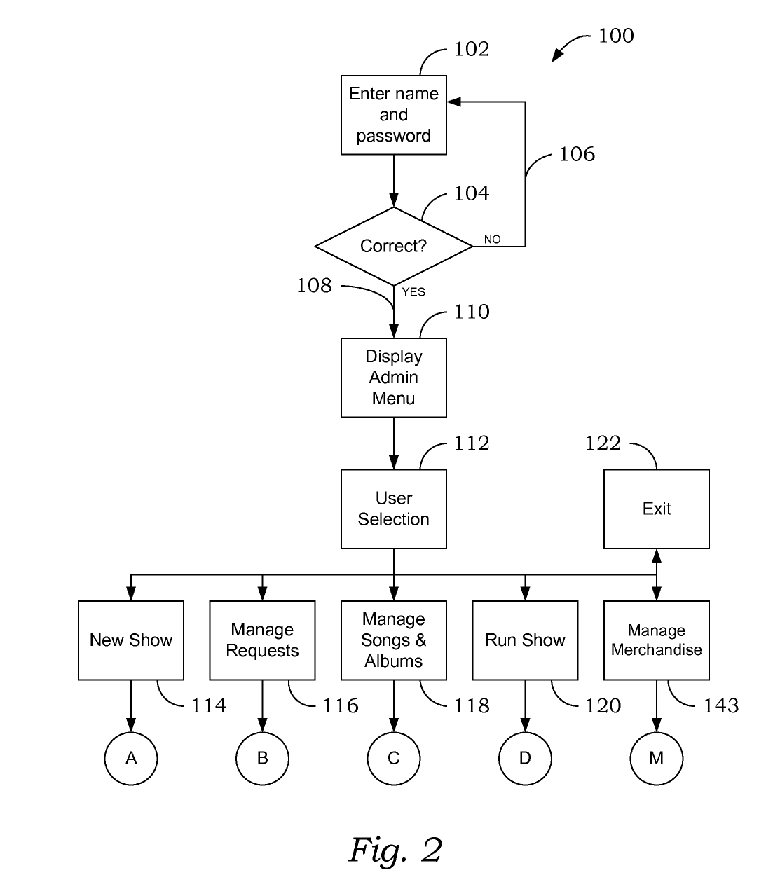

The server application software (See FIG. 2) is generally indicated by reference numeral 100. An administrator logs into the server or central computer 22 by entering a name and password 102, which are compared to the login information stored on the server 104. If the name or password is not correct 106, then the administrator is prompted to enter a name and password again 102. If the name and password entered are correct 108, then an Admin Menu 110 is displayed for selection 112. The Admin menu 110 selection 112 may include New Show 114, Manage Requests 116, Manage Songs and Albums 118, Run Show 120, Manage Merchandise 143 and Exit 122, for example. The interface between the local computer 24 and the server 22 may be protected by a secure socket layer (SSL) to encrypt and secure the connection, for example.

If New Show 114 is selected, a check is made to determine if previous show data has been stored 124. If this is the first show 126 then the administrator is prompted to enter background information 128 such as band or performer's name, address, contact information, web address. Next, concert-specific information may be entered 130 such as a concert code, date, time, location, hashtags and webtags for the show. If this isn't the first show 132, then previously entered information may be retrieved from the server 134 and processing continued to enter concert-specific information 130. The entered data may be saved 136 on the server 22 in a database 40 or other format.

Next, the administrator is prompted to enter two or more encore songs 138. The fields may be open text fields or present a pick list based on previous entries if this isn't the first show, or based on the band/performer's name entered previously, the names of songs may be retrieved from the web address entered or from a third part such as iTunes, for example. Next, one or more dates and locations for the next concert(s) is entered 140. The information is then displayed for the administrator 142. The administrator is given the opportunity to review the information to determine if it is correct 144. If it is correct 146 then the information is stored 148 in the database 40 on the server 22, and processing returns to the Display Admin Menu 110. If the information is not correct 150, processing returns to block 128 where the fields may be edited to correct any mis-entered information.

From the Display Admin Menu 110 the administrator may select 112 the Manage Requests 116 menu option. The application allows third parties to select from a menu of the band's or performer's songs to be played at the next concert. In this way, the band/performer may tailor the play list for the concert according to the public's desires. Requests may be submitted anonymously, only by registered public users, or by any such combination. Requests may be submitted electronically through a website, email, text message or other electronic messaging service. From the Manage Requests 116 menu, the song request information is retrieved 152 from the server 22 and displayed 154 on the administrator's computer 24. The song requests may be displayed individually in chronological order, may be sorted by song name or may be compiled with a running total, for example. After viewing the requests, the administrator may decide to reset the requests or not 156. If the administrator decides to not reset the requests 158, then processing returns to the Display Admin Menu 110. If the administrator decides to reset the requests 160, the administrator may be given the option to save the requests 162. If the administrator decides not to save the requests 164, a confirmation box may be presented 166 to confirm deletion of the requests before returning to the Display Admin Menu 110. If the administrator decides to save the requests 168, then the administrator may be prompted to enter a file name or the system may automatically generate a file name for the administrator 170. Processing then returns to the Display Admin Menu 110.

From the Display Admin Menu 110 the administrator may select 112 the Manage Songs and Albums option 118. Song and album information is requested 172 from the server 22 and displayed 174. The administrator may be presented with five menu options, such as New Album 176, Edit Album 178, New Song 180, Edit Song 182 and Exit 184, for example. If New Album 176 is selected, then an Enter Album Information Menu is displayed 186. The administrator may enter an album name 188. The administrator may then decide to have the system search for the new album information or manually enter the album information 190. If the administrator selects to have the system search for the new album information 192, the search results, if any, are displayed 194 for verification 196. If the album information, including names of the songs and album artwork, for example, is correct 198, then the administrator may simply save the information 200 and return to the Display Admin Menu 110.

If the information is not correct, not complete, or no information has been located 202, then the administrator may choose whether to edit the album 204. If the administrator decides to not edit the album 206, processing is returned to the Display Admin Menu 110. If the administrator decides to edit the album 208 then processing continues to the Edit Album 178 menu selection.

When the Edit Album menu option 178 is selected either manually or through the above process path, a list of albums may be displayed 210, including the album name, if entered above. The administrator may then select the album to be edited 212. An Edit Album Menu 214 is displayed for administrator selection 216 which may include Edit Album Name 218, Change Album Artwork 220, Add Songs 222, Delete Album 224, and Exit 226, for example.

If Edit Album Name 218 is selected, the administrator may change the album name 228 and save the entered text 230 to the server 22 and return to the Edit Album Menu 214.

If the administrator selects Change Album Artwork 220, the administrator may enter a file name or browse for the desired file 232 to upload 234 to the server 22, and processing returns to the Edit Album Menu 214.

If the administrator selects to Add Songs 222 to the selected album, the administrator may enter a song name 236 and iteratively add 238 additional songs 240 to the album until complete 242. At this point the songs are saved 244 to the server 22 and then displayed 246 for confirmation 247. If correct 248, control returns to the Edit Album Menu 214. If changes need to be made 250, processing continues to the Edit Song menu selection 182.

If the administrator selects to Delete Album 224, an album name is selected 225 and a confirmation is presented 227. If the administrator decides to not delete the album 229, processing returns to the Edit Album Menu 214. If the administrator confirms deletion of the album 231 then the album is deleted from the server 233 and processing returns to the Edit Album Menu 214.

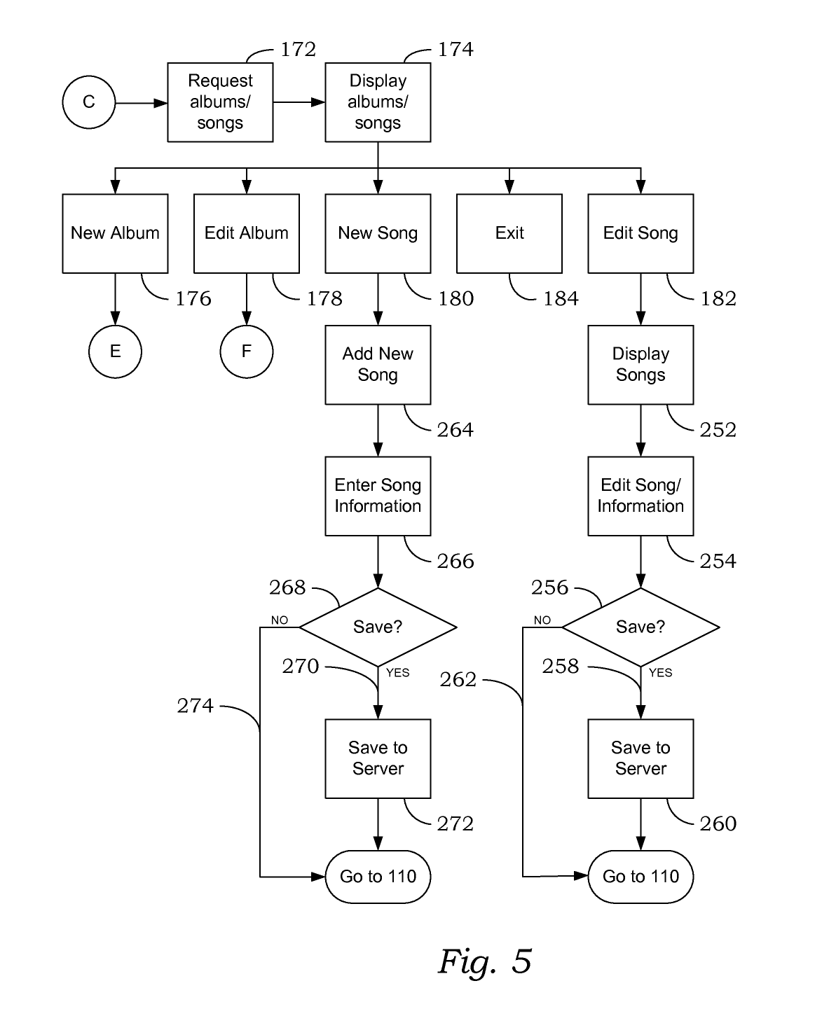

Referring to FIG. 5, if the Edit Song menu option 182 is selected, a list of songs associated with the currently selected album is displayed 252. Typographical or other errors in the song name may be corrected as desired. With each song, other information may be displayed for edit 254, such as a link to purchase and download the song, a link to the lyrics of the song, animation which may be associated with the song, and handset motion colors, for example. The animations and motion colors may be manually set or automatically set as desired. Once the desired changes are made, the administrator has the option to save or discard the changes 256. If the administrator saves the changes 258, the changes are saved to the server 260 and processing returns to the Admin Menu 110. If the administrator discards the changes 262, then the changes are discarded and processing returns to the Admin Menu 110.

If the administrator selects the New Song menu option 180, an Add New Song screen is displayed 264. The New Song screen may include text fields to enter the name of the song, an album name to which to associate the song, a link to purchase and download the song, a link to the lyrics of the song, animation which may be associated with the song, and handset motion colors 266, for example. After the information is entered the administrator is given the option to save or discard the entered data 268. If save is chosen 270, the information is saved to the server 272 and processing returns to the Admin Menu 110. If discard is chosen 274, the information is not saved and processing returns to the Admin Menu 110.

From the Display Admin Menus 110, if the administrator selects 112 Run Show 120, a list of concerts is displayed for the administrator to select from 121 (FIG. 6). Next the administrator may select a song 123 and then select run to start the concert 125. The information related to the song and the associated animation is pushed out to the concert attendees 127, or otherwise made available over the network. When the song is over the administrator may select end 129. Next the administrator is presented with a question as to whether this was the last song 131. If it is not the last song 133, then processing returns to block 123 to select another song. If it is the last song 135, then a check is made to determine if an encore song will be played 137. If an encore song is to be played 139, then processing returns to block 123 to select another song. If an encore song will not be played 141, processing returns to the Display Admin Menu 110.

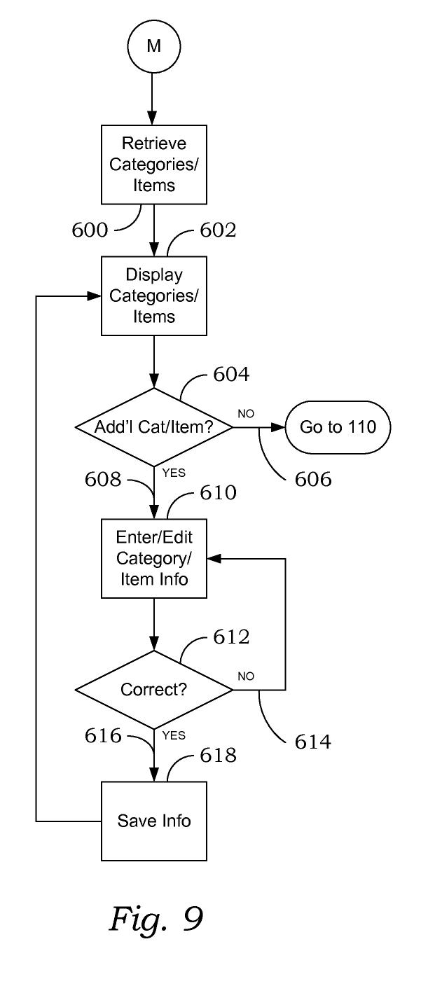

From the Display Admin Menus 110, if the administrator selects 112 Manage Merchandise 143, a list of categories and/or items is retrieved 600 from the server 22 (FIG. 9). The categories and/or items are displayed 602 and the administrator is presented with an option to add additional categories and/or items or edit existing categories and/or items 604. If no additional categories and/or items are to be added or edited 606, then processing returns to the Admin Menu 110.

If a category and/or item is to be added or edited 608, the category and/or item is edited 610 and displayed for the administrator to determine if it is correct 612. If it was not entered/edited correctly 614, the category and/or item is presented for editing again 610. If it was correctly entered or edited 616, the information is saved 618 on the server 22 and processing returns to display the categories and/or items 602.

From the Display Admin Menus 110, the administrator may also select 112 Exit 122, which exits the server application software.

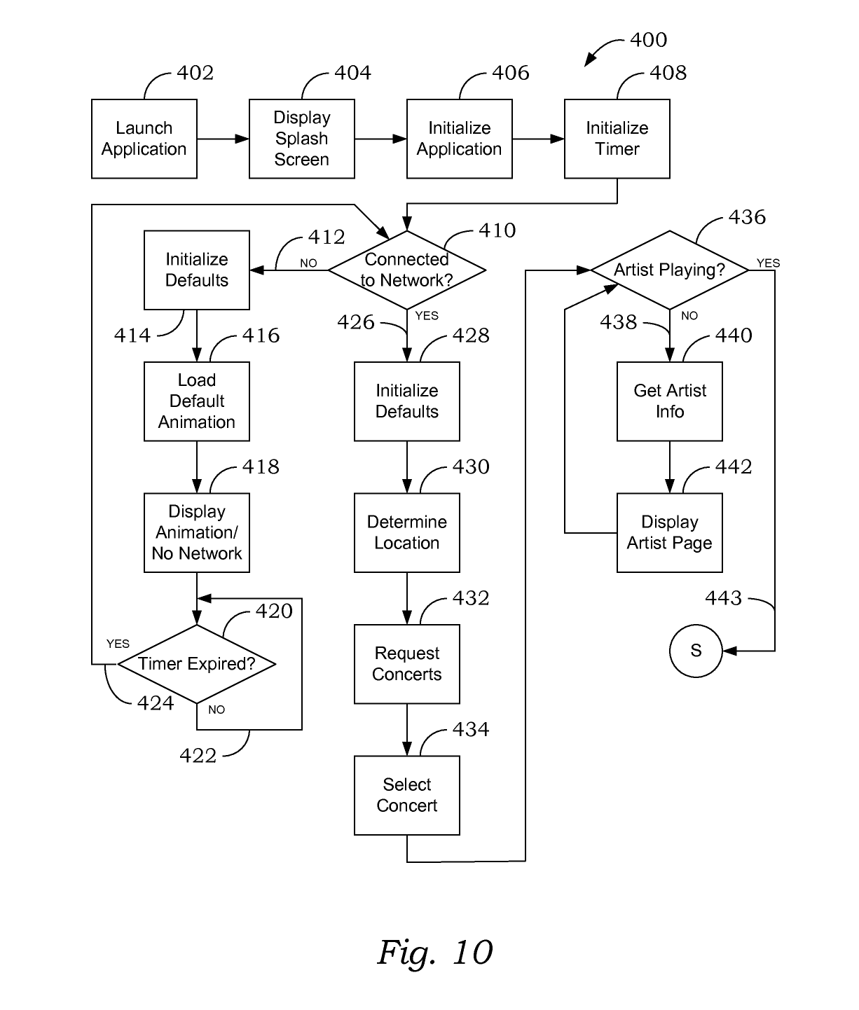

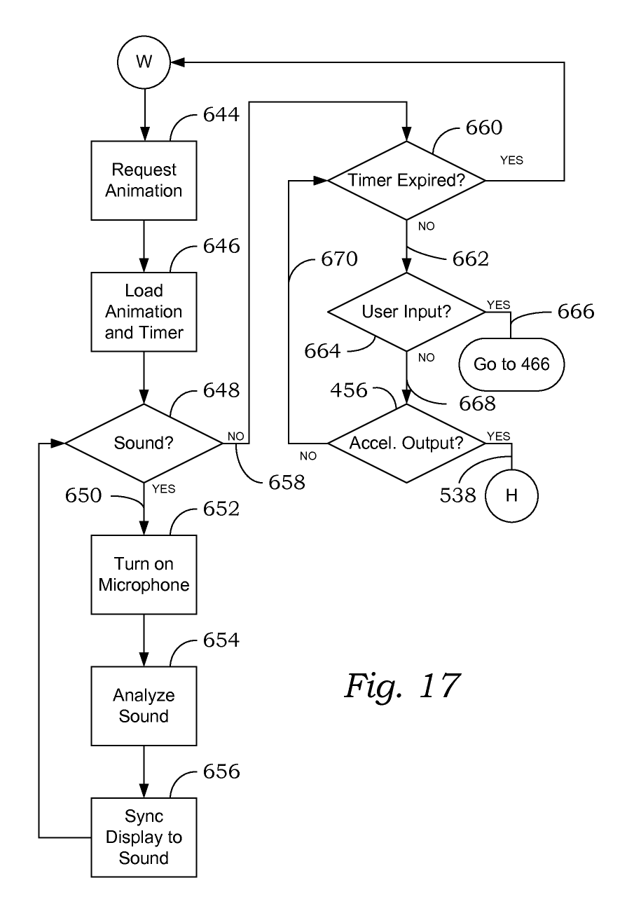

Referring to FIGS. 1 and 10-20, a flow chart for an interactive application to be loaded and run on a portable electronic device 42 is generally indicated by reference numeral 400. Once the application is loaded and installed on the user's portable electronic device 42, such as an iPod with Wifi, Smartphone or iPhone, for example, the concert application may be launched 402. An initial splash screen may be displayed 404. The application is initialized 406 and a timer initialized 408. The timer is set to an interval at which to query the server for song changes.

Next, the application checks for network connectivity 410. The electronic device 42 may connect 44 to a wireless portal or Wifi 30 or connect 46 through a cellular network 48, which then connects 50 to the internet 36. If the device is not connected to a network, 412, preloaded default settings such as a countdown timer are initialized 414, a default animation is loaded 416 and a message is displayed indicating that the device 42 is not connected to the network 418. The countdown timer runs and is checked to determine if it has expired 420. If it has not expired 422, the system remains in an idle state until the timer expires. When the timer expires 424, the electronic device 42 again attempts to connect to the network 410.

If the device 42 successfully connects to the network 426, the defaults are initialized 428, the location is determined from a GPS or other location information 430 based on the location, the relevant concert information is requested 432 and Selected 434.

Next, the server 22 may send concert/artist information 434 to the connected electronic device 42. The concert information 434 may include a concert start time or a simple on/off concert start indicator, for example. The electronic device application determines if the concert has started 436. While the concert has not started 438, artist information is requested 440 and may be displayed 442 on the electronic device which periodically changes to display each album artwork.

When the concert starts 443, song information such as lyrics, album art, trivia, or history, for example, is retrieved 630 from the server 22, and a control menu 632 is displayed. The control menu 632 may include selections such as Live Menu 634, View Cart 636, Merchandise 638, and Main Menu 640, for example.

If the user selects Live Menu 634, a live menu is displayed 466, which may include selection for Artist 468, Share 475, Request 472, Encore 474.

Although the sequences and process steps are described sequentially, it should be understood that various process steps may be running in parallel with other process steps or may be interrupt-driven with a watchdog timer set to check the status of any interrupt flags or other indicators to launch an appropriate process or otherwise respond to an interrupt. Additionally, it should be understood that if the hardware of an electronic device 42 does not support a particular feature, such as not having an accelerometer, then that portion of the processing may be bypassed, for example.

If the user selects live menus 634 then a live menu is displayed 466. The live menu 466 may include selections such as Artist 468, Share 470, Request 474, Encore 474, Animation Interaction 634, Merchandise, 638 and Main Menu 480, for example.

If the user selects Share 470, the electronic device 42 is connected to a third party website 52 online store and linked directly to the currently playing song 471. Alternatively, the user may be linked to the album.

If the user selects Request 472, a list of songs may be displayed 481. The user may select a song from a pull down menu 483 and enter information such as the user's name and/or email address, and at least one reason for picking the song, for example. A check is made for an entry in each of the required fields 485. If all required fields have not been entered 487, then the user is returned to block 483. If all required fields have been entered 489, then the information is sent to the server 491, a disclaimer or message is displayed 493, and processing returns to the control menu 466.

If the user selects Encore 474 from the control menu 466, the previously entered encore choices are displayed 496. The user may select from the list of encore songs 498. The user's selection is sent to the server 500, where the encore song votes are tallied 502, the running vote tally is displayed 504, and processing returns to the control menu 466.

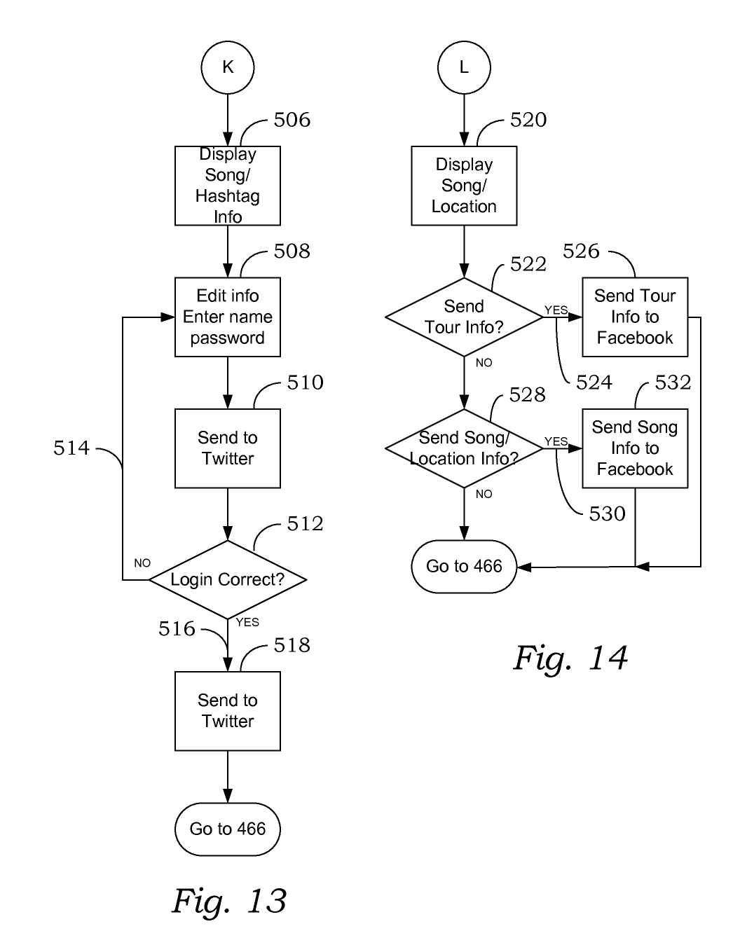

If the user selects Share 470, the user may select Twitter 476 or Facebook 478, for example. If the user selects Twitter 476 (FIG. 13), song name, location information and hash tag information is displayed 506. The user may enter a message, his or her Twitter account user name and password 508. The entered data is sent to Twitter 510 and the account information checked 512. If the account information is not correct 514, processing returns to block 508. If the account information is correct 516, then the song name, location information, hash tag and message is sent to Twitter 518. Processing then returns to the control menu 466.

If the user selects Facebook 478 (FIG. 14) then the currently playing song name and concert location are displayed 520. The user is given an option to send tour information, or song and concert information to their Facebook page 522. If the user selects Tour Info 524, the tour information is retrieved from server 22 and sent to the user's Facebook page 526, and processing returns to the control menu 466. If the user selects Song and Location Info 528 to send song and location info 530, then the song and concert location information is sent to the user's Facebook page 532, and processing returns to the control menu 466.

From the control menu 466, if the user selects Lyrics 636, song information is requested 640 from the server 22 and the lyrics for the currently-playing song is displayed 642, and processing returns to the control menu 466.

From the control menu 466, if the user selects Back 480, then processing returns to block 630 and the current animation for the currently playing song is loaded.

From the control menu 466, if the user selects Animation Interaction 634, an animation is requested 644 from the server 22 corresponding to the currently-playing song. The animation is loaded along with a timer indicating the end of the song 646. The animation may be based on concert sounds 648. If based on sound 650, the device's microphone is activated 652, the received sound is analyzed 654, and the selected animation is synched to the sound 656. If the animation is not based on the sounds 658, the timer is checked 660. If it has not expired 662, then the device checks for user inputs 664 via the touch screen or other device controls. If the user touches the screen 666, for example, process returns to the control menu 466. If there is no user input 668, an accelerometer in the electronic device 42 is checked for an output indicating movement 456. If no output is detected 670, processing returns to block 660.

If the user is moving the electronic device 42 from side to side, for example, an accelerometer output is received 538, then the sync setting is checked 540 (FIG. 18). The sync setting utilizes Bluetooth® or other local area wireless communication technology to sense the presence of nearby devices and allow the devices to sync their displays and animations to create a similar or dissimilar effect. If the sync setting is on 542, then an animation is loaded 544 based on information received 56 from nearby mobile client device(s) 54 (see FIG. 1). Next, movement direction based on the accelerometer output is determined 546. If movement of the electronic device 42 is to the left 548, then a stage left animation variance is displayed 550. If movement of the electronic device 42 is to the right 552, then a stage right animation variance is displayed 554. If the sync setting is off 556, then the left and right movement display animations are based on predetermined displays and/or animations for the particular music or song being played 558. A timer is periodically checked to determine if the song has ended or animation has changed 555. If the timer has not expired 557, processing continues at block 546. If the timer has expired 559, processing returns to block 456.

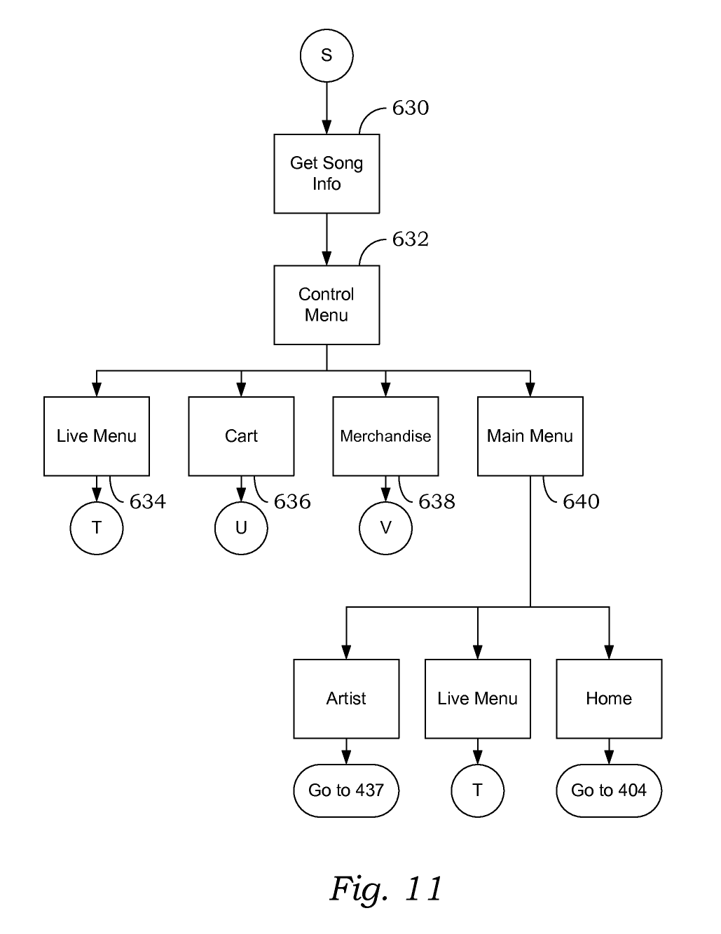

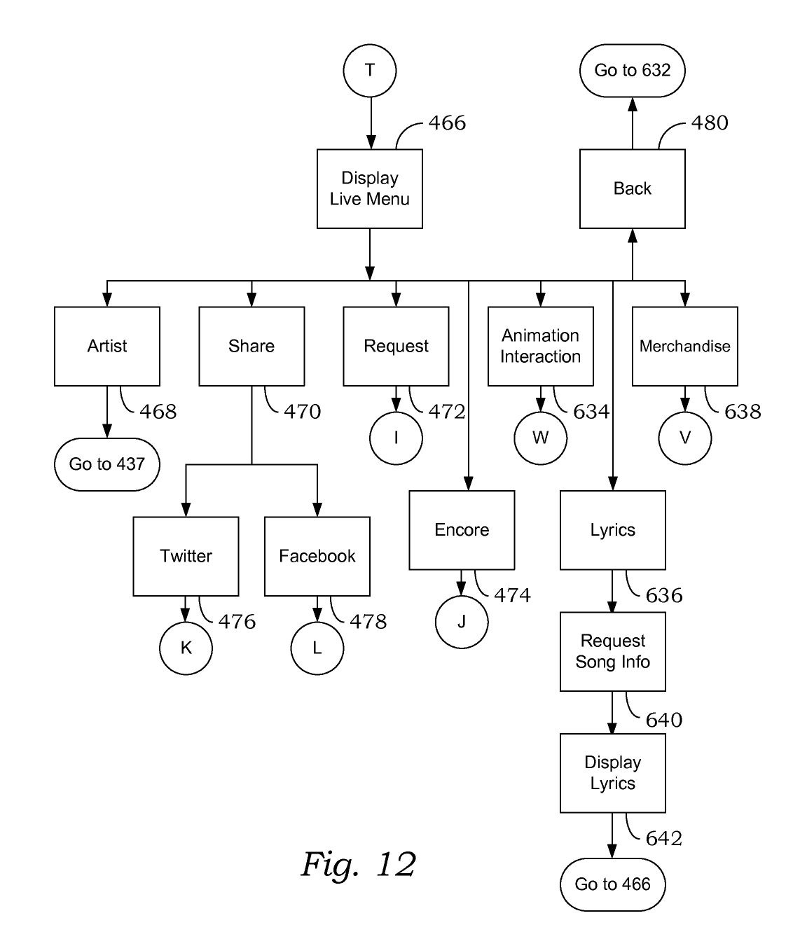

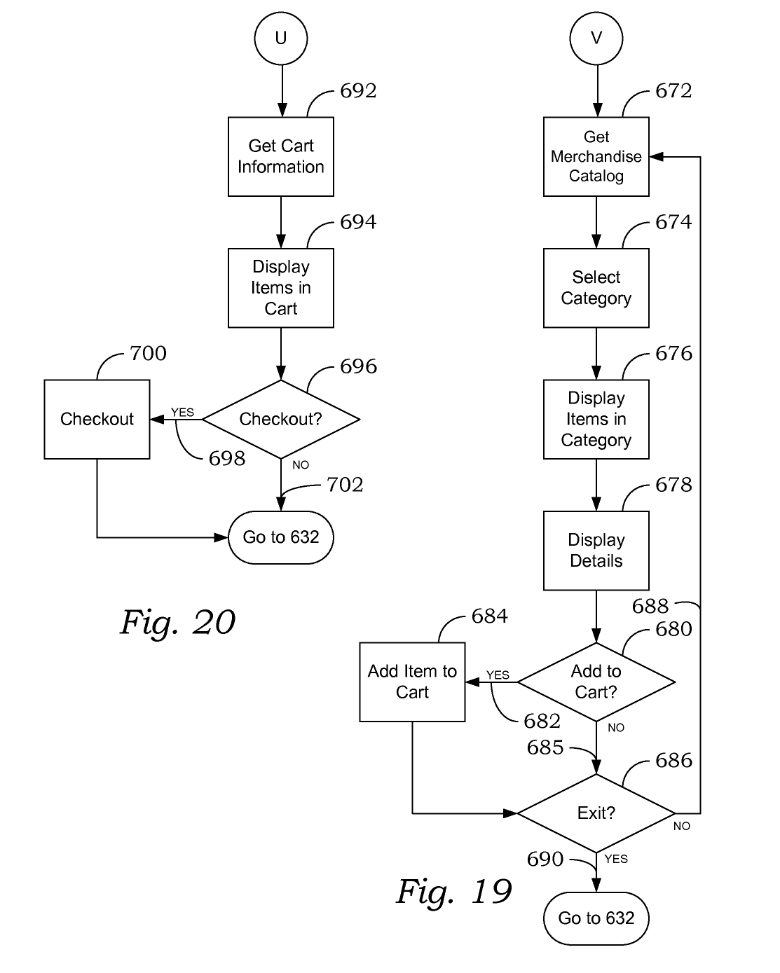

Referring to FIG. 12, if the user selects Merchandise 638, a merchandise catalog is retrieved 672 from the server 22 (FIG. 19). The user may select a category 674 such as apparel, CDs, or posters, for example. Items within the selected category are displayed 676 and the user may select an item to display the details 678. An add to cart button is displayed 690 along with the item details. The user may add the item to the cart 682, or not add the item to the cart 685. If the user selects the add to cart button 682, the item is placed in an electronic shopping cart 684. At this point the user is given a choice of continuing to shop or to exit 686. If the user decides to continue shopping 688, processing continues at block 672. If the user chooses to exit 690, then processing returns to block 632 (FIG. 11).

Referring to FIG. 11, if the user chooses View Cart 636, the cart information is retrieved 692, and displayed 694. A checkout button is displayed 696. If the user selects checkout 698, a checkout processing screen is presented 700 to enter payment information according to methods known in the art. After checkout, processing returns to block 632. If the user decides to not checkout 702, processing returns to block 632.

In use, the administration application 100 allows an artist to set up concert information, album information, song information, merchandise information, etc. as desired for users to enjoy a concert or other related offline activities related to the artist/band.

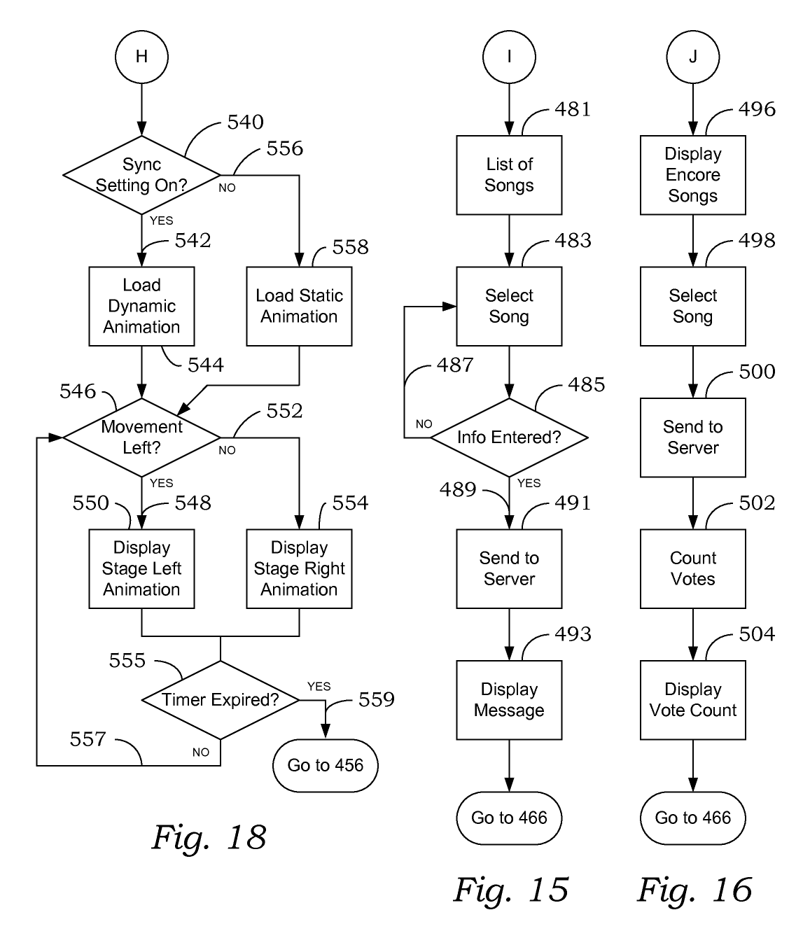

Likewise, a user following an artist or band may use the concert application to follow an artist or band and participate in a live concert as desired. For example, the Animation Interaction selection 634 (FIGS. 12, 17 and 18) allows the user to request and display animations coordinated with the songs being played at the concert, with animations displayed on stage, or with other surrounding devices, for example, creating a more intimate concert experience, or display a animation of a lighter to call for an encore performance. Additionally, a user may directly request 472 songs from a list of songs to be played (FIGS. 12 and 15), or may request an encore song 474 to be played during an encore performance (FIGS. 12 and 16), for example, further enhancing the concert experience.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A method of interacting with a concert attendee comprising the steps of:
setting up a concert performance by entering concert performance information on a server, establishing a connection to said server with an electronic device operating concert application software,
displaying a control menu on a display of said electronic device, and
selection a concert interaction,
wherein said step of selecting a concert interaction provides concert-related information from said server to said electronic device, and
wherein said step of selecting a concert interaction provides user-specific information from said electronic device to said server.

2. The method of claim 1 wherein said setting up step includes entering concert date, time and location information.

3. The method of claim 1 wherein said setting up step includes electronically receiving a song request from a user before a concert date and saving or deleting said request.

4. The method of claim 1 wherein said setting up step includes entering album and song information.

5. The method of claim 1 wherein said setting up step includes initiating an interactive session for a select concert.

6. The method of claim 1 wherein said setting up step includes entering concert and/or artist-related merchandise for purchase by said concert attendee.

7. The method of claim 1 wherein said establishing a connection step includes establishing a wireless connection to said server by said electronic device.

8. The method of claim 1 wherein said selecting step includes selecting a live concert interaction.

9. The method of claim 8 wherein said live concert interaction includes requesting artist information from said server for display on said electronic device.

10. The method of claim 8 wherein said live concert interaction includes transmitting concert information received from said server by said electronic device to an online social media site.

11. The method of claim 8 wherein said live concert interaction includes sending a song request from said electronic device selected from a list of songs received by said electronic device from said server.

12. The method of claim 8 wherein said live concert interaction includes sending an encore song request from said electronic device selected from a list of encore songs received by said electronic device from said server.

13. The method of claim 8 wherein said live concert interaction includes requesting lyrics of a song as the song is being played by said artist from said server for display on said electronic device.

14. The method of claim 8 wherein said live concert interaction includes requesting a list of concert-related merchandise from said server for display and selection on said electronic device for purchase by said concert attendee.

15. The method of claim 8 wherein said live concert interaction includes requesting animation interaction from said server by said electronic device.

16. The method of claim 15 wherein said animation interaction includes receiving an animation from said server and synchronizing said animation to sound received by a microphone of said electronic device.

17. The method of claim 15 wherein said animation interaction includes receiving an animation from said server and displaying said animation on said display of said electronic device.

18. The method of claim 15 wherein said animation interaction includes receiving an animation from said server and synchronizing said animation with on-stage animation displays and movement of said electronic device by said concert attendee.

19. The method of claim 15 wherein said animation interaction includes receiving an animation from said server by said electronic device and synchronizing said animation with one or more proximal electronic devices.
